(19) United States
(12) Patent Application Publication
(10) Pub. No.: US 2011/0149957 A1
(43) Pub. Date: Jun. 23, 2011

(54) METHOD OF TRACEBACK AND ISOLATION OF HIGH-RISK FLIGHT DATA PACKET AND APPARATUS FOR THE SAME

(75) Inventors: Seoung-Hyeon LEE, Daejeon (KR); Jong-Wook Han, Daejeon (KR); Hyo-Dal Park, Seoul (KR); Do-Woo Kim, Daejeon (KR); Deok-Gyu Lee, Yongin (KR); Seung-Hee Oh, Daejeon (KR)

(73) Assignee: Electronics and Telecommunications Research Institute, Daejeon (KR)

(21) Appl. No.: 12/819,877

(22) Filed: Jun. 21, 2010

(30) Foreign Application Priority Data
Dec. 21, 2009 (KR) 10-2009-0128387

(51) Int. Cl. H04L 12/56

(52) U.S. Cl. 370/389

(57) ABSTRACT

Disclosed is a method of traceback and isolation of a high-risk flight data packet and an apparatus for the same. The method of traceback and isolation of a high-risk flight data packet includes monitoring, by a flight data packet monitoring unit, whether a high-risk flight data packet is generated in flight data packets transmitted to a flight data processing apparatus; tracebacking a transfer path for the high-risk flight data packet on a network by a path tracebacking unit when the high-risk flight data packet is generated; and isolating, by an isolation processing unit, a flight data terminal transmitting the high-risk flight data packet to the transfer path from an aeronautical telecommunication network. The present invention can increase the security, reliability, and availability of the air traffic control system and can be performed without stopping the allocation of services to authenticated users of the air traffic control system.

### BACKGROUND OF THE INVENTION

1. Field of the Invention

The present invention relates to an air traffic control system, and in particular, to a technology capable of traceback and isolation of flight data packet transferred between a flight data processing system and a flight data terminal through an aeronautical telecommunication network that is a backbone network for building a next-generation air traffic control system.

2. Description of the Related Art

An aeronautical fixed telecommunication network (AFTN), which is a backbone network of an air traffic control system, is an X.25-based closed type telecommunication network that includes a separate network address system, router equipment, etc., for the aeronautical fixed telecommunication network. The aeronautical fixed telecommunication network has lower security risk from the inside and outside as compared with an open type telecommunication network. However, the aeronautical fixed telecommunication network has problems in that manufacturing companies avoid the development of products such as a router and a dedicated line in an X.25 format, the maintenance cost is increased, it is difficult to accommodate surging air data, and it is difficult to support communication, navigation surveillance/air traffic management (CNS/ATM) of a next-generation air traffic control system, etc.

The aeronautical telecommunication network (ATN) is a next-generation digital telecommunication network that integrates and operates wired/wireless air telecommunication networks built and operated by each airline or airport-related agency according to the recommendation of international civil aviation organization (ICAO) in order to solve the problems occurring in the existing aeronautical fixed telecommunication network.

The aeronautical telecommunication network is recommended so that it includes common interface services based on ISO OSI reference models and telecommunication services and applications allowing a data subnetwork for ground, air-to-ground, and airbone electronic devices to be mutually operated by adopting protocols and is designed to support the CNS/ATM.

However, according to the “review, of web application security and intrusion detection in air traffic control systems” published in 2009, about 3000 or more weak points were highlighted in the web application for the air traffic control as a result of checking the air control system of U.S. to which a portion of the aeronautical telecommunication network is applied.

In other words, although the aeronautical telecommunication network is an efficient telecommunication network to support the next-generation air traffic control system, it is expected that a serious problem will occur in providing safe aircraft control unless efficient security measures using an interface such as web applications to support a new air traffic control system are prepared.

Therefore, an urgent need exists for a flight data packet managing method capable of more safely controlling an aircraft based on the aeronautical telecommunication network.

### SUMMARY OF THE INVENTION

The present invention proposes to solve the above problems. It is an object of the present invention to increase security, reliability, and availability for an air control system by monitoring a flight data packet transferred between a flight data processing system and a flight data terminal that are connected through an aeronautical telecommunication network and when a high-risk flight data packet is generated, tracebacking high-risk flight data and isolating a source of the high-risk flight data in the aeronautical telecommunication network.

Further, it is another object of the present invention to efficiently traceback a high-risk flight data packet transmission path by using agent information generated by routers configuring an aeronautical telecommunication network.

In order to achieve the above object, according to an embodiment of the present invention, there is provided a method of traceback and isolation of high-risk flight data packet, including: monitoring, by a flight data packet monitoring unit, whether a high-risk flight data packet is generated in flight data packets transmitted to a flight data processing apparatus; tracebacking a transfer path for the high-risk flight data packet on a network by a path tracebacking unit when the high-risk flight data packet is generated; and isolating, by an isolation processing unit, a flight data terminal transmitting the high-risk flight data packet to the transfer path in an aeronautical telecommunication network.

The method of traceback and isolation of high-risk flight data packet may further include generating agent information by allowing a router relaying the transmission of the flight data packets to use the flight data packets.

The agent information may include a previous IP address field, a current IP address field, a next IP address field, and a masking or not field. The tracebacking the transfer path may traceback the transfer path by using the agent information.

The tracebacking the transfer path may include: collecting the agent information including the masking or not field indicating that the flight data packet is masked; and forming the transfer path using the collected agent information.

The forming the transfer path may form the transfer path by connecting IP addresses of the previous IP address field and the next IP address field corresponding to the collected agent information.

The isolating the flight data terminal in the aeronautical telecommunication network may instruct the filtering the high-risk flight data packet by all the routers existing in the aeronautical telecommunication network and stop the transfer of all the data transferred from the IP corresponding to the flight data terminal.

According to another exemplary embodiment of the present invention, there is provided an apparatus of monitoring and tracebacking a flight data packet, including: a flight data packet monitoring unit that monitors whether a high-risk flight data packet is generated in flight data packets transmitted to a flight data processing apparatus; a path tracebacking unit that tracebacks a transfer path for the high-risk flight data packet on a network when the high-risk flight data packet is generated; and an isolation processing unit that isolates a flight data terminal transmitting the high-risk flight data packet to the transfer path in an aeronautical telecommunication network.

The apparatus of monitoring and tracebacking a flight data packet may further include an agent information collecting unit that collects agent information from routers configuring the aeronautical telecommunication network.

The agent information may include a previous IP address field, a current IP address field, a next IP address field, and a masking or not field.

The path tracebacking unit may form the transfer path by connecting IP addresses of the previous IP address field and the next IP address field corresponding to the collected agent information.

According to the embodiments of the present invention, it can isolate a risk such as a service stop due to the high-risk flight data packet generated in the air traffic control system based on the aeronautical telecommunication network and safely provide air traffic control service to the user.

Further, the present invention isolates only the flight data terminal transferring the high-risk flight data packet in the aeronautical telecommunication network, thereby making it possible minimize inconvenience to other users and improve the overall security of the air traffic control system.

### BRIEF DESCRIPTION OF THE DRAWINGS

FIG. 1 is a diagram showing an air traffic control system based on an aeronautical telecommunication network according to an exemplary embodiment of the present invention;

FIG. 2 is a diagram showing an example of a flight data packet used in an air traffic control system shown in FIG. 1;

FIG. 3 is a diagram showing an example of agent information used in an air traffic control system shown in FIG. 1;

FIG. 4 is an operational flow chart showing a method of traceback and isolation of a high-risk flight data packet according to an exemplary embodiment of the present invention;

FIG. 5 is an operational flow chart showing an example of a step of tracebacking transfer path shown in FIG. 4; and

FIG. 6 is a block diagram showing a flight data packet monitoring and tracebacking apparatus according to an embodiment of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted Exemplary embodiments of the present invention are provided so that those skilled in the art may more completely understand the present invention. Accordingly, the shape, the size, etc., of the elements in the figures may be exaggerated for explicit comprehension.

Hereinafter, exemplary embodiments of the present invention will be described in detail with reference to the accompanying drawings.

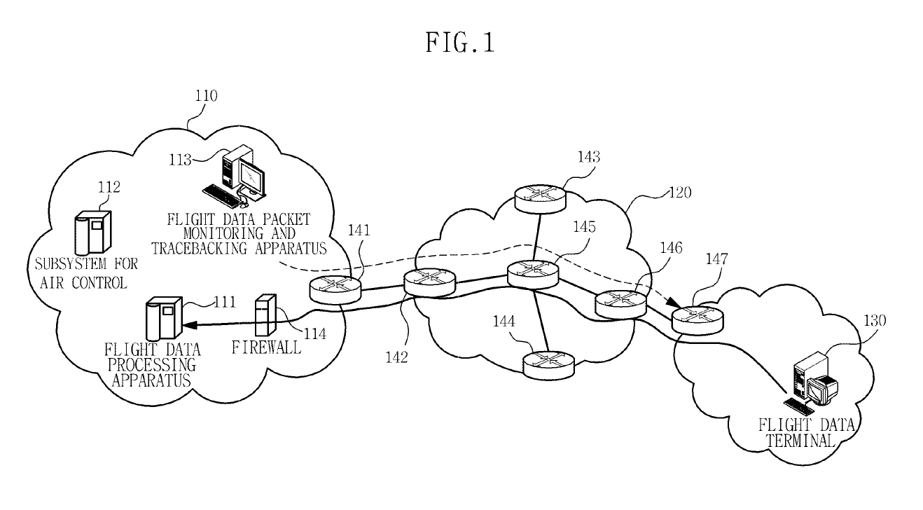

FIG. 1 is a diagram showing an air traffic control system based on an aeronautical telecommunication network according to an exemplary embodiment of the present invention.

Referring to FIG. 1, the air traffic control system includes an air control system 110, an aeronautical telecommunication network (ATN) 120, and a flight data terminal 130.

The air control system 110 may include a flight data processing apparatus 111, a subsystem for air control 112, a flight data packet monitoring and tracebacking apparatus 113, and a firewall 114.

The aeronautical telecommunication network 120 includes a plurality of routers 142, 143, 144, 145, and 146.

Each router 142, 143, 144, 145, and 146 is installed with an agent program for generating traceback information. Therefore, the router serves to form the transfer path of the flight data packet.

The air traffic control system including the flight data processing apparatus 111 and the flight data terminal 130 based on the aeronautical telecommunication network may configure one site.

The flight data processing apparatus 111 and the flight data terminal 130 may be connected to each other by a specific interface.

The flight data packet monitoring and tracebacking apparatus 113 may be positioned in the air control system 110. In this case, the flight data packet monitoring and tracebacking apparatus 113 may exist as an independent separate apparatus and may exist as a portion of other apparatuses such as the flight data processing apparatus 111 or the subsystem 112 for air control, etc.

The flight data packet transferred through the flight data terminal 130 may be transferred to the flight data processing apparatus 111 via the routers 147, 146, 145, 142, and 141 and the firewall 114.

In this case, the flight data packet monitoring and tracebacking apparatus 113 checks whether the transferred flight data packet is a high-risk flight data packet and when it is determined whether the flight data packet is the high-risk flight data packet, tracebacks the path through which the corresponding flight data packet is transferred by operating a tracebacking module to find out the flight data terminal 130 and isolates it from the aeronautical telecommunication network.

The agent program installed in each of the routers 141, 142, 143, 144, 145, 146, and 147 according to the present invention stores the routing information of the routed flight data packet in the database. In this case, the routing information may include a previous IP address, a next IP address, flight data packet contents, etc. In other words, the agent program may store the previous IP address, the next IP address, and the flight data packet contents for all the flight data packet transferred through the corresponding router and database them.

In addition, when the flight data packet monitoring and tracebacking apparatus 113 senses packets suspected as the high-risk flight data packet, the flight data packet monitoring and tracebacking apparatus 113 may request the agent information as the agent program installed in each of the routers 141, 142, 143, 144, 145, 146, and 147. In this case, the flight data packet monitoring and tracebacking apparatus 113 may instruct a masking for the flight data packet suspected as the high-risk flight data packet, the agent program searches the routing information stored in the database to add the masking information indicating that the flight data packet is masked to the routing information when the routing information on the corresponding high-risk flight data packet is in the database, thereby making it possible to provide the flight data packet monitoring and tracebacking apparatus 113. The agent program includes the masking information indicating that the flight data packet is not masked even when there is no routing information on the corresponding high-risk flight data packet, thereby making it possible to return the routing information.

In addition, when the agent program receives the masking request for the high-risk flight data packet from the flight data packet monitoring and tracebacking apparatus 113, it can serve to isolate the routing for the flight data terminal transferring the corresponding packet.

The agent information generated in the agent program may be masking or not for the IP address of the corresponding router, the IP address of the previous router, the IP address of the next router, and the flight data packet.

When the flight data terminal 130 transfers the flight data packet whose contents are damaged, the flight data packet monitoring and tracebacking apparatus 113 senses the risk of the flight data packet transferred to the air control system 110 via the routers of the aeronautical telecommunication network 120. The flight data packet monitoring and tracebacking apparatus 113 immediately instructs masking of the corresponding high-risk flight data packet to the agents installed in the router of the aeronautical telecommunication network and all the agents update the agent information and transfers the corresponding information to the flight data packet monitoring and tracebacking apparatus 113. If there is no flight data packet to be masked in the flight data packet monitoring and tracebacking apparatus 113, the unmasked information is transferred to the flight data packet monitoring and tracebacking apparatus 113. The flight data packet monitoring and tracebacking apparatus 113 aligns the information collected from the agent as a key value for the masking or not, virtualizes the transfer path based on the previous/current/next IP addresses according to the masking or not, and tracebacks the position of the flight data terminal transferring the corresponding flight data packet. The isolation of the tracebacked flight data terminal instructs the isolation of the flight data packet to the agent that exists in the virtual path formed in the flight data packet monitoring and tracebacking apparatus 113 and the router in which the agent is installed isolates the transfer of the corresponding flight data packet.

The transfer path tracebacking according to the present invention may use the agent information configured by the agent to reconfigure the path on the network to which the high-risk flight data packet is transferred and then, filter the high-risk flight data packet in all the routers configuring the aeronautical telecommunication network and isolate the corresponding flight data terminal from the aeronautical telecommunication network.

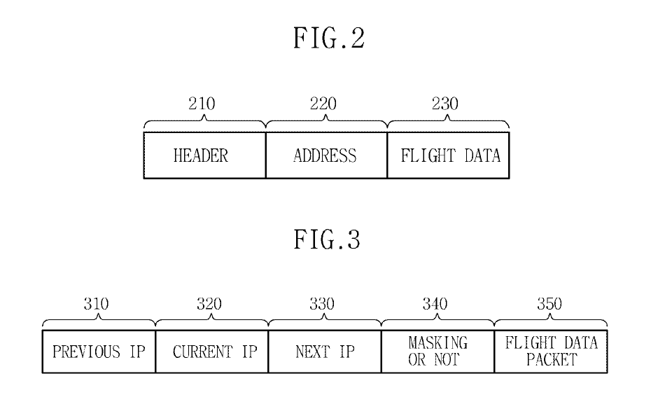

FIG. 2 is a diagram showing an example of a flight data packet used in an air traffic control system shown in FIG. 1.

Referring to FIG. 2, the flight data packet includes a header field 210, an address field 220, and a flight data field 230.

The header field 210 includes a flight data message header.

The address field 220 includes a unique identifier of the flight data terminal. In this case, since the unique identifier of the flight data terminal is different from the IP address and the flight data packet includes the unique identifier of the flight data terminal, not the IP address, such that the path tracebacking process of the present invention using the agent information is needed.

The flight data field 230 is a data field that is transferred to the flight data processing apparatus 111.

FIG. 3 is a diagram showing an example of agent information used in an air traffic control system shown in FIG. 1.

Referring to FIG. 3, the agent information includes a previous IP field 310, a current IP field 320, a next IP field 330, a masking or not field 340, and a flight data packet field 350.

The previous IP field 310 includes the IP address of the previous router where the agent is installed in the flight data packet transfer path.

The current field 320 includes the IP address field of the current router where the agent is installed in the flight data packet transfer path.

The next field 330 includes the IP address field of the next router where the agent is installed in the flight data packet transfer path.

The masking or not field 340 indicates whether the high-risk flight data packet determined by the system of the present invention is masked.

The flight data packet field 350 includes the flight data packet transferred through the aeronautical telecommunication network. For example, the flight data packet field 350 may include the flight data packet shown in FIG. 2.

In this case, the previous IP field 310, the current IP field 320, and the next IP field 330 may be used for configuring the tracebacking path for the high-risk flight data packet.

The fields shown in FIGS. 2 and 3 are by way of example only and may be changed according to the request of the user or the provided service.

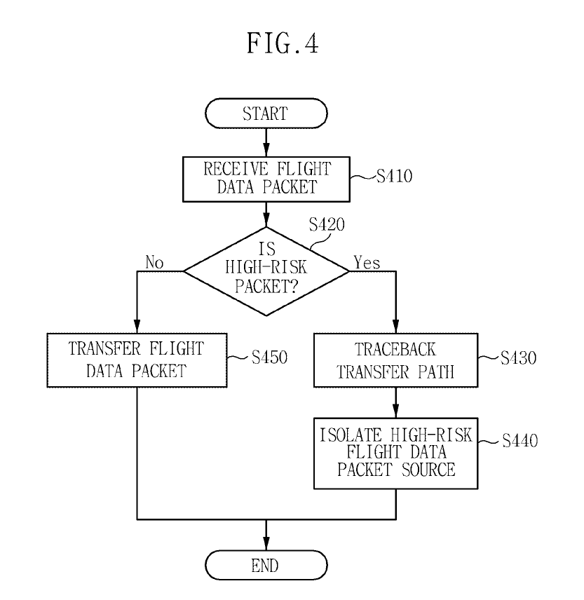

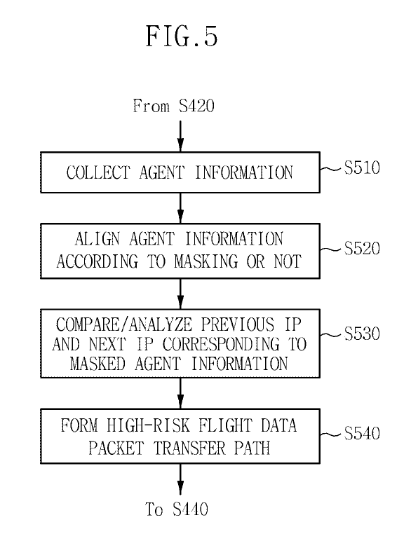

FIG. 4 is an operational flow chart showing a method of traceback and isolation of a high-risk flight data packet according to an exemplary embodiment of the present invention.

Referring to FIG. 4, the method of traceback and isolation of high-risk flight data packet according to an exemplary embodiment of the present invention first receives the flight data packet (S410).

Further, the method of traceback and isolation of high-risk flight data packet checks whether the received flight data packet is the high-risk packet (S420).

In this case, the flight data packet may be transferred to the flight data processing apparatus.

As the determination result of step S420, when the flight data packet is determined as the high-risk packet, the method of traceback and isolation of high-risk flight data packet tracebacks the transfer path of the corresponding flight data packet on the network (S430).

After tracebacking the transfer path on the network through step S430, the method of traceback and isolation of high-risk flight data packet isolates the flight data terminal transferring the high-risk flight data packet to the transfer path on the network from the aeronautical telecommunication network (S440).

As the determination result of step S420, when the flight data packet is not determined as the high-risk packet, the method of traceback and isolation of high-risk flight data packet transfers the corresponding flight data packet to the flight data processing apparatus (S450).

Although not shown in FIG. 4, the method of traceback and isolation of high-risk flight data packet may further include generating agent information by allowing the router relaying the transmission of the flight data packets to use the flight data packets.

In this case, the agent information may include a previous IP address field, a current IP address field, a next IP address field, and a masking or not field.

In this case, step S430 can traceback the transfer path by using the agent information.

Step S440 instructs the filtering of the high-risk flight data packet by all the routers existing in the aeronautical telecommunication network and can stop the transfer of all the data transferred from the IP corresponding to the flight data terminal transferring the high-risk flight data packet.

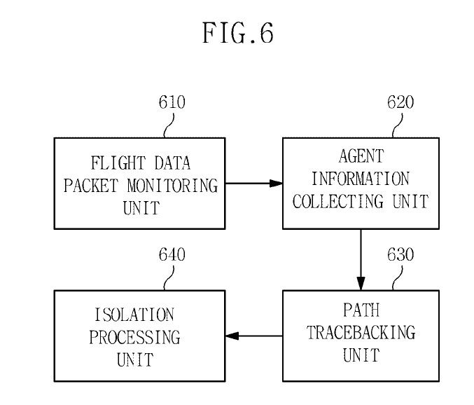

FIG. 5 is an operational flow chart showing an example of the transfer path tracebacking of step S430 shown in FIG. 4.

Referring to FIG. 5, the transfer path tracebacking step collects the agent information from the routers configuring the aeronautical telecommunication network (S510).

In this case, the agent information may be generated/stored by the agent installed in each router.

Further, the transfer path tracebacking step aligns the agent information according to, the masking or not (S520). That is, the transfer path tracebacking step separately classifies the agent information including the masking or not field indicating that it is masked.

In addition, the transfer path tracebacking step compares/analyzes the previous IP and the next IP of the agent information corresponding to the masking or not field indicating that it is masked (S530).

The router and the link of the router are formed by the comparison/analysis of step S530 to form the virtual path and the formed path becomes the transfer path of the high-risk flight data packet (S540).

In other words, when steps S530 and S540 for all the masked agent information are repeated, the path on the network transferring the high-risk flight data packet may be configured.

FIG. 6 is a block diagram showing the flight data packet monitoring and tracebacking apparatus according to an embodiment of the present invention.

Referring to FIG. 6, the flight data packet monitoring and tracebacking apparatus according to an exemplary embodiment of the present invention includes a flight data packet monitoring unit 610, an agent information collecting unit 620, a path tracebacking unit 630, and an isolation processing unit 640.

The flight data packet monitoring unit 610 monitors whether the high-risk flight data packet is generated in the flight data packets transferred to the flight data processing apparatus.

The agent information collecting unit 620 collects the agent information from the routers configuring the aeronautical telecommunication network. In this case, the agent information may be generated/stored by the agent installed in each router and may be a type of data shown in FIG. 3.

The path tracebacking unit 630 tracebacks the transfer path for the high-risk flight data packet on the network when the high-risk flight data packet is generated.

In this case, the path tracebacking unit 630 uses the agent information generated by the routers configuring the aeronautical telecommunication network, thereby making it possible to traceback the transfer path.

In this case, the agent information may include a previous IP address field, a current IP address field, a next IP address field, and a masking or not field.

The path tracebacking unit 630 collects the masking information including the masking or not field indicating that it is masked and uses the collected masking information, thereby making it possible to form the transfer path. In this case, the path tracebacking unit 630 connects the previous IP address field corresponding to the collected masking information and the IP address corresponding to the next IP address field, thereby making it possible to form the transfer path.

The isolation processing unit 640 isolates the flight data terminal transmitting the high-risk flight data packet to the transfer path from the aeronautical telecommunication network.

The isolation processing unit 640 instructs the filtering of the high-risk flight data packet to all the routers existing on the aeronautical telecommunication network and stops the transfer of all the data transferred from the IP corresponding to the flight data terminal, such that it can isolate the flight data terminal transferring the high-risk flight data packet from the aeronautical telecommunication network.

The method of traceback and isolation of high-risk flight data packet and apparatus for the same according to the present invention as described above are not limited to the configuration and method of the embodiments as described above, but the embodiments may be configured by selectively combining all the embodiments or some of the embodiments so that various modifications can be made.

What is claimed is:

1. A method of traceback and isolation of high-risk flight data packet, comprising:
monitoring, by a flight data packet monitoring unit, whether a high-risk flight data packet is generated in flight data packets transmitted to a flight data processing apparatus;
tracebacking a transfer path for the high-risk flight data packet on a network by a path tracebacking unit when the high-risk flight data packet is generated; and
isolating, by a isolation processing unit, a flight data terminal transmitting the high-risk flight data packet to the transfer path from an aeronautical telecommunication network.

2. The method of traceback and isolation of high-risk flight data packet according to claim 1, further comprising generating agent information using the flight data packets by a router relaying the transmission of the flight data packets.

3. The method of traceback and isolation of high-risk flight data packet according to claim 2, wherein the agent information includes a previous IP address field, a current IP address field, a next IP address field, and a masking or not field.

4. The method of traceback and isolation of high-risk flight data packet according to claim 3, wherein the tracebacking the transfer path tracebacks the transfer path by using the agent information.

5. The method of traceback and isolation of high-risk flight data packet according to claim 4, wherein the tracebacking the transfer path includes:
collecting the agent information including the masking or not field indicating that the flight data packet is masked; and
forming the transfer path using the collected agent information.

6. The method of traceback and isolation of high-risk flight data packet according to claim 5, wherein the forming the transfer path forms the transfer path by connecting IP addresses of the previous IP address field and the next IP address field corresponding to the collected agent information.

7. The method of traceback and isolation of high-risk flight data packet according to claim 1, wherein the isolating the flight data terminal from the aeronautical telecommunication network instructs the filtering the high-risk flight data packet by all the routers existing in the aeronautical telecommunication network and stops the transfer of all the data transferred from the IP corresponding to the flight data terminal.

8. The method of traceback and isolation of high-risk flight data packet according to claim 1, further comprising transferring the flight data packets to the flight data processing apparatus if it is determined that the flight data packet is not the high-risk flight data packet.

9. An apparatus of monitoring and tracebacking a flight data packet, comprising:
a flight data packet monitoring unit that monitors whether a high-risk flight data packet is generated in flight data packets transmitted to a flight data processing apparatus;
a path tracebacking unit that tracebacks a transfer path for the high-risk flight data packet on a network when the high-risk flight data packet is generated; and
an isolation processing unit that isolates a flight data terminal transmitting the high-risk flight data packet to the transfer path from an aeronautical telecommunication network.

10. The apparatus of monitoring and tracebacking a flight data packet according to claim 9, further comprising an agent information collecting unit that collects agent information from routers configuring the aeronautical telecommunication network.

11. The apparatus of monitoring and tracebacking a flight data packet according to claim 10, wherein the path tracebacking unit tracebacks the transfer path by using the agent information generated by the routers.

12. The apparatus of monitoring and tracebacking a flight data packet according to claim 11, wherein the agent information includes a previous IP address field, a current IP address field, a next IP address field, and a masking or not field.

13. The apparatus of monitoring and tracebacking a flight data packet according to claim 12, wherein the path tracebacking unit collects the agent information including the masking or not field indicating that the flight data packet is masked; and forms the transfer path using the collected agent information.

14. The apparatus of monitoring and tracebacking a flight data packet according to claim 13, wherein the path tracebacking unit forms the transfer path by connecting IP addresses of the previous IP address field and the next IP address field corresponding to the collected agent information.

15. The apparatus of monitoring and tracebacking a flight data packet according to claim 9, wherein the isolation processing unit instructs the filtering for the high-risk flight data packet by all the routers existing in the aeronautical telecommunication network and stops the transfer of all the data transferred from the IP corresponding to the flight data terminal to isolate the flight data terminal transmitting the high-risk flight data packet in the aeronautical telecommunication network.
